(19) United States
(12) Patent Application Publication
(10) Pub. No.: US 2008/0123479 A1
(43) Pub. Date: May 29, 2008

(54) APPARATUS AND METHOD FOR RECORDING/REPRODUCING HOLOGRAPHIC DATA AND HOLOGRAPHIC DATA STORAGE MEDIUM

(75) Inventor: Ji-deog Kim, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/750,004

(22) Filed: May 17, 2007

(30) Foreign Application Priority Data
Nov. 24, 2006 (KR) 10-2006-0117088

(51) Int. Cl. G11B 7/00; G11B 3/70

(52) U.S. Cl. 369/44.28; 369/284

(57) ABSTRACT

An apparatus for recording/reproducing holographic data which can record holographic data in a data storage medium and can reproduce recorded data includes a light source emitting a laser beam, a lens unit focusing the laser beam emitted from the light source by classifying the laser beam into a reference beam passing through a first area and a signal beam passing through a second area and having a first lens focusing the signal beam to a first focus and a second lens focusing the reference beam to a second focus, and a driving unit driving the first lens to vary the first focus in a depth direction of the data storage medium.

### CROSS-REFERENCE TO RELATED PATENT APPLICATIONS

This application claims the benefit of Korean Patent Application No. 10-2006-0117088, filed on Nov. 24, 2006, in the Korean Intellectual Property Office, the disclosure of which is incorporated herein in its entirety by reference.

### BACKGROUND OF THE INVENTION

1. Field of the Invention

Apparatuses and methods consistent with the present invention relate to recording/reproducing holographic data by recording data in three dimensions and reproducing the recorded data using a volume holography, and a holographic data storage medium.

2. Description of the Related Art

Related art optical storage technology using holograms has attracted attention. A data storage method using a hologram stores data in the form of an optical interference pattern in an inorganic crystal or polymer material which is photosensitive. The optical interference pattern is formed using two laser beams exhibiting interference. That is, a reference beam having no data and a signal beam having a predetermined data interfere with each other forming an interference pattern, which causes a chemical or physical change in a photosensitive storage medium, which enables recording.

To reproduce data from the recorded interference pattern, a reference beam similar to the light beam used for recording is incident on the interference pattern recorded in the storage medium. Accordingly, the interference pattern causes a diffraction so that a signal beam is restored and the data is reproduced.

FIG. 1 shows a related art holographic data recording/reproducing apparatus. FIG. 2 shows that data is recorded by a data recording apparatus in a data storage medium using the interference between a reference beam and a signal beam. Referring to FIGS. 1 and 2, a holographic data recording/reproducing apparatus includes a data recording apparatus 20 and a data reproducing apparatus 30. The data recording apparatus 20 includes a light source 21, a beam splitter 22, and a focusing lens unit 23. The data reproducing apparatus 30 includes an objective lens 31 and an optical signal detection unit 32. The focusing lens unit 23 includes a multi-focal lens (not shown).

The area of the multi-focal lens is divided into a first area having a first focus P and a second area having a second focus Q. The light passing through the first area is focused at the first focus P while the light passing through the second area is focused at the second focus Q. When a laser beam emitted by the light source 21 is projected to both of the first and second areas P and Q, the laser beam is divided into a first laser beam focused at the first focus P and a second laser beam focused at the second focus Q. One of the first and second laser beams is a signal beam and the other of the first and second beams is a reference beam. Accordingly, interference is generated in a predetermined area of the data storage medium 10 and holographic data is recorded corresponding thereto. However, the recording is performed in 2-D from the inner circumference to the outer circumference along a concentric or spiral track on a disk.

A high density recording is possible using an appropriate multiplexing method. That is, data is recorded to be overlapped at the same storing position in a data storage medium 10 by changing the incident angle, phase, and wavelength of a reference beam. Accordingly, according to the above multiplexing method, high density recording is possible because the data stored to be spatially overlapped can be separated during reproduction. Furthermore, when data is stored in 3-D by changing the position not only in a track direction but also in a depth direction with respect to the data storage medium 10 where holographic data is stored, the data can be recorded/reproduced at a higher density.

### SUMMARY OF THE INVENTION

The present invention provides an apparatus and method for recording/reproducing holographic data capable of recording at a higher density by having a lens actuated to move the focus in a depth direction of the data storage medium which enables multilayer data recording, and a holographic data storage medium.

According to an aspect of the present invention, an apparatus for recording/reproducing holographic data which records holographic data in a data storage medium and reproduces recorded data comprises a light source emitting a laser beam, a lens unit focusing the laser beam emitted from the light source by classifying the laser beam into a reference beam passing through a first area and a signal beam passing through a second area and having a first lens focusing the signal beam at a first focus and a second lens focusing the reference beam at a second focus, and a driving unit driving the first lens to vary the first focus in a depth direction of the data storage medium.

According to another aspect of the present invention, a holographic data storage medium where holographic data is recorded comprises a substrate, a first buffer layer formed on the substrate, a first reflection surface having a partially reflecting characteristic as a boundary surface between the substrate and the first buffer layer, a recording layer formed on the first buffer layer, a second buffer layer formed on the recording layer, a cover layer formed on the second buffer layer, and a second reflection surface having a partially reflecting characteristic as a boundary surface between the substrate and the first buffer layer, wherein the second reflection surface is used for servo control during recording and the second reflection surface and the first reflection surface are used for the servo control during reproduction.

According to another aspect of the present invention, a method for recording/reproducing holographic data by classifying a laser beam into a reference beam and a signal beam and projecting the classified laser beam onto a data storage medium to record data by an interference pattern of the reference beam and the signal beam and reproduce the recorded data comprises forming a focus of the reference beam at a position of a fixed depth in the data storage medium and allowing a focus of the signal beam to vary in a depth direction ofthe data storage medium, wherein data is recorded in a multilayer structure in the depth direction of the data storage medium.

### BRIEF DESCRIPTION OF THE DRAWINGS

The above and other aspects and features of the present invention will become more apparent by describing in detail exemplary embodiments thereof with reference to the attached drawings in which:

FIG. 1 illustrates the structure of a related art holographic data recording/reproducing apparatus;

FIG. 2 illustrates recording of data in a data storage medium using the interference between a reference beam and a signal beam in a data recording apparatus;

FIG. 3 illustrates the structure of a holographic data recording/reproducing apparatus according to an exemplary embodiment ofthe present invention;

FIGS. 4A through 4D show exemplary steps of recording data in a multilayer structure in a data storage medium according to an exemplary embodiment of the present invention; and

FIG. 5 illustrates the structure of a holographic data recording/reproducing apparatus according to another exemplary embodiment ofthe present invention.

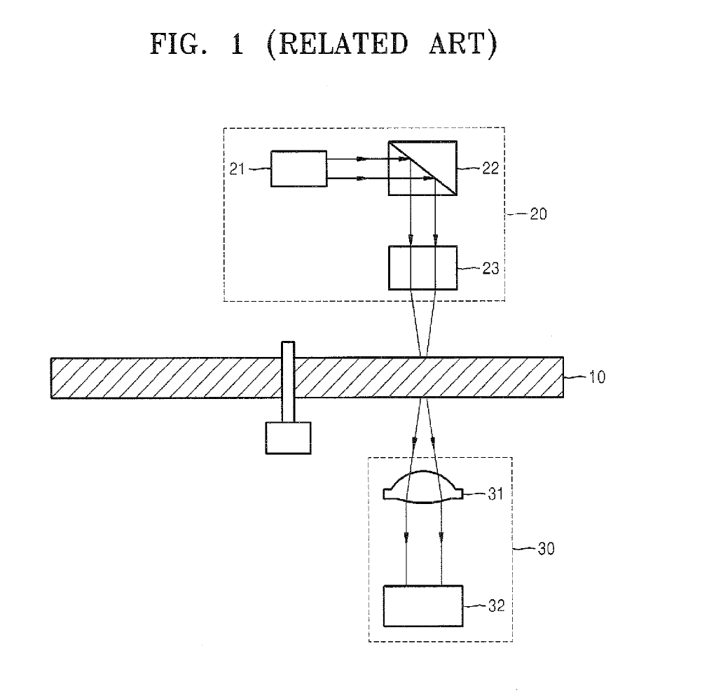

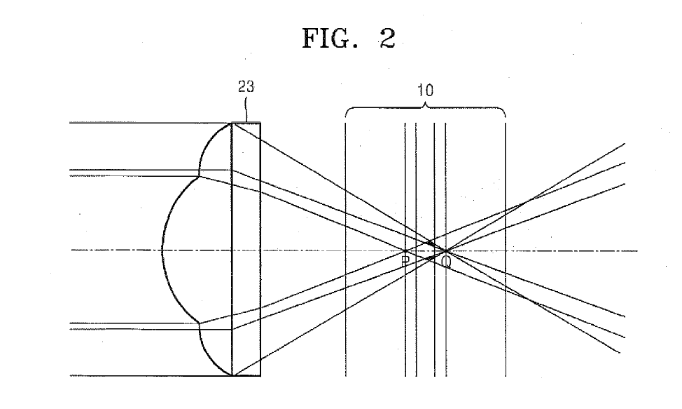

### DETAILED DESCRIPTION OF THE EXEMPLARY EMBODIMENTS

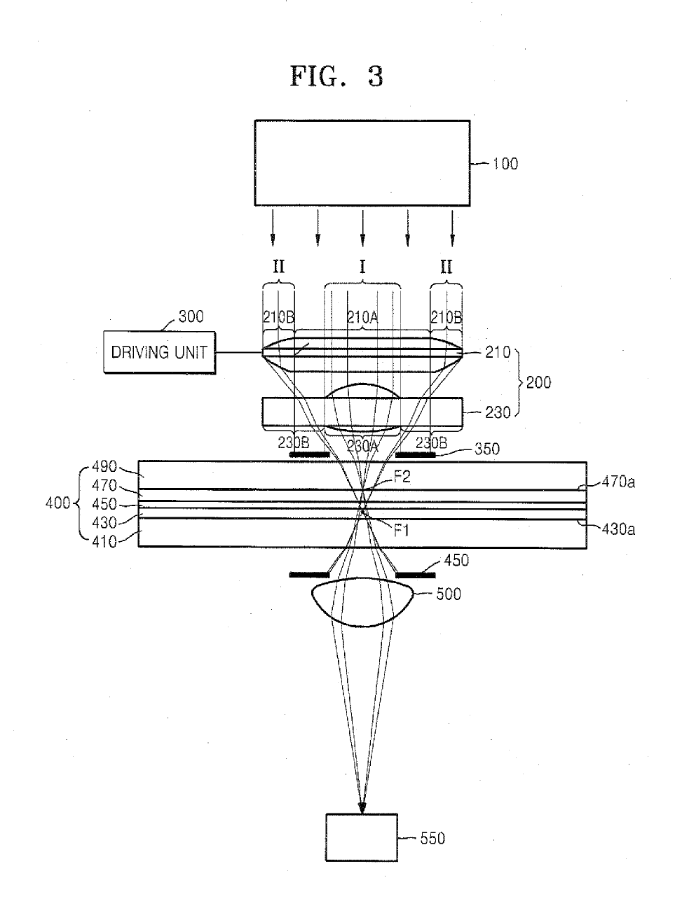

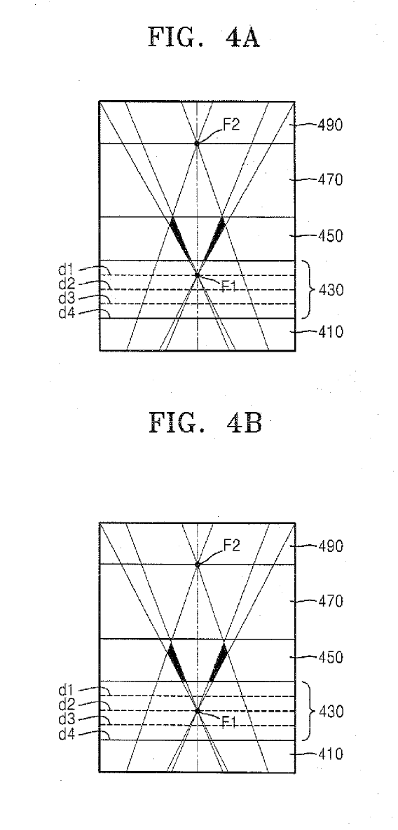

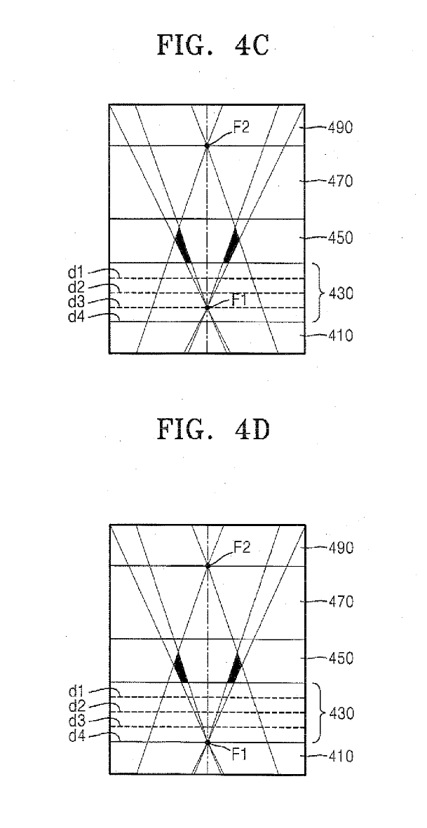

FIG. 3 illustrates the structure of a holographic data recording/reproducing apparatus according to an exemplary embodiment of the present invention. FIGS. 4A through 4D show exemplary steps of recording data in a multilayer structure in a data storage medium. Referring to FIGS. 3 and 4A through 4D, an apparatus for recording/reproducing holographic data according to the present exemplary embodiment includes a light source 100 emitting a laser beam toward a data storage medium 400, a lens unit 200 focusing the laser beam emitted from the light source 100 by classifying the laser beam into a reference beam passing through a first area I and a signal beam passing through a second area II, and a driving unit 300. A beam splitter (not shown) for changing the path of light according to the arrangement of the light source 100 to proceed toward the data storage medium 400 can be provided between the light source 100 and the lens unit 200. A collimating lens (not shown) for collimating the light from the light source can be further provided.

The classification of the reference beam and the signal beam according to the above areas shown in FIG. 3 is exemplary so that alternatively, the light passing through the first area I can be a signal beam and the light passing through the second area II can be a reference beam. In the following description, the light passing through the first area I is a reference beam and the light passing through the second area II is a signal beam.

The lens unit 200 includes a first lens 210 and a second lens 230. The first lens 210 focuses the signal beam at a first focus F₁ while the second lens 230 focuses the signal beam at a second focus F₂. The first lens 210 is formed such that only an area corresponding to the signal beam has a refractive power. The area of the first lens 210 consists of a first flat area 210A having no refractive power and a first lens area 210B formed around the first flat area 210A and having a refractive power. The first flat area 210A is an area through which a light beam including the reference beam passes, while the first lens area 210B is an area through which the signal beam passes.

The second lens 230 is formed such that only an area corresponding to the reference beam has a refractive power. The area of the second lens 230 consists of a second lens area 230A having a refractive power and a second flat area 230B formed around the second lens area 230A and having no refractive power. The second lens area 230A is an area through which the reference beam passes so that the reference beam passing through the second lens area 230A is focused at a second focus F₂ in the data storage medium 400. The second flat area 230B is an area through which a light beam including the signal beam passes and which is flat and has no refractive power.

A first beam block unit 350 is arranged on an optical path between the second lens 230 and the data storage medium 400, and blocks the light beam passing through both of the first flat area 210A of the first lens 210 and the second flat area 230A of the second lens 230, that is, a light beam that is neither the signal beam nor the reference beam, not to be incident on the data storage medium 400. The first beam block unit 350 can be an aperture capable of controlling a projection area through which a beam passes.

The structure of the lens unit 200 is not limited to the exemplary structure of the first and second lenses 210 and 230 and any structure capable of classifying the light beam into the signal beam and the reference beam to be focused at the first focus F₁ and the second focus F₂, respectively, can be used. For example, the first flat area 210A of the first lens 210 can be an aperture. Also, the second lens 230 can be an objective lens having a diameter corresponding to the reference beam. Also, the first flat area 210A and the second lens area 230A are formed to correspond to each other. The first lens area 210B and the second flat area 230B are formed to correspond to each other. In this case, the first beam block unit 350 may not be needed.

The driving unit 300 drives the first lens 210 such that the first focus F₁ of the first lens 210 can vary in the depth direction of the data storage medium 400. For example, a voice coil motor or piezoelectric ultrasonic motor can be used as the driving unit 300.

The data storage medium 400 has a multilayer structure including a recording layer 450. For example, the data storage medium 400 has a structure in which a first buffer layer 430, a recording layer 450, a second buffer layer 470, and a cover layer 490 are sequentially deposited on a substrate 410. A first reflection surface 430a is formed as a boundary surface between the substrate 410 and the first buffer layer 430 and has a partially reflecting characteristic. A second reflection surface 470a is formed as a boundary surface between the second buffer layer 470 and the cover layer 490 and has a partially reflecting characteristic.

A photodetection unit 550 is arranged on the side of the data storage medium 400 opposite to the side of the lens unit 200 to reproduce data by detecting an optical signal from the data storage medium 400. A second beam block unit 450 can be arranged on the optical path between the data storage medium 400 and the photodetection unit 550 so that the photodetection unit 550 can detect only the light corresponding to a reproduction signal of the optical signal from the data storage medium 400. Also, a focusing lens 500 for focusing light toward the photodetection unit 550 can be further arranged on the optical path between the data storage medium 400 and the photodetection unit 550.

In FIG. 3, the reference beam that is diffracted and transmitted by the recorded hologram is used as a reproduction signal. In this case, since the signal beam restored by the reference beam projected to the hologram corresponds to noise, the second beam block unit 450 blocks the signal beam. For example, an aperture capable of controlling a projecting area can be used as the second beam block unit 450. Although the second beam block unit 450 is illustrated to be located in front of the focusing lens 500, it can alternatively be located at the rear of the focusing lens 500. Also, when the focusing lens 500 is formed to have the same diameter as the diameter of the beam corresponding to the reproduction signal, the second beam block unit 450 may not be needed.

An operation of recording and reproducing holographic data in a multilayer structure in the data storage medium 400 using the apparatus for recording/reproducing holographic data according to the exemplary embodiment will be described in detail. The light beam emitted by the light source 100 toward the data storage medium 400 is classified into the reference beam having no data and the signal beam having data to be recorded. The signal beam, for example, is a laser beam whose light intensity is modulated according to the data to be stored. The light beam including the reference beam is not affected by transmitting the first flat area 210A of the first lens 210. The light corresponding to the reference beam of the transmitted light beam proceeds toward the second lens area 230A of the second lens 230 and the other beam proceeds toward the second flat area 230B of the second lens 230. The reference beam transmitting the second lens area 230A is focused at the second focus F₂ located at a position of the data storage medium 400.

The second reflection surface 470a of the data storage medium 400 is formed to perform servo control for tracking and focusing during recording. The second focus F₂ is formed on the second reflection surface 470a. The light transmitted at the first flat area 210A and the second flat area 230B is blocked by the first beam block unit 350 not to be incident on the data storage medium 400.

The light corresponding to the signal beam passes through the first lens area 210B of first lens 210 and then the second flat area 230B of the second lens 230 and is focused at the first focus F₁ located at a position of the data storage medium 400. The position of the first focus F₁ is not limited to the position illustrated in the drawings and any position is available where an interference pattern can be formed by the interference between the reference beam and the signal beam generated on the recording layer 450 of the data storage medium 400.

The driving unit 300 drives the first lens 210 to vary in the depth direction of the data storage medium 400 so that the position ofthe first focus F₁ changes. FIGS. 4A through 4D illustrate data being recorded in a multilayer structure as the position where the interference between the reference beam and the signal beam occurs in the recording layer 450 of the data storage medium 400 changes due to the movement of the first focus Fₗ. FIGS. 4A through 4D respectively show the cases where the first focus F₁ is formed on a first surface d₁ through a fourth surface d₄. The first surface d₁, through fourth surface d₄ illustratively show the movement of the first focus F₁ of the signal beam in the depth direction of the data storage medium 400, and are not physical boundary surfaces.

As the first focus F₁ moves in the depth direction of the data storage medium 400, the position where the interference pattern of the reference beam and the signal beam is formed is slightly changed. The interval at which the first focus F₁ moves can be appropriately determined within a range in which the separation and reproduction of the interference pattern is possible. Although the first focus F₁ is illustrated to move in the first buffer layer 430, the exemplary embodiment and variants thereof are not limited thereto.

When the interference pattern of the reference beam and the signal beam is moved in the depth direction within the recording layer 450, the first focus F₁ can be moved into the other layers of the data storage medium 400. When the first lens 210 is driven to move the first focus F₁, the second lens 230 does not move, and the second focus F₂ is fixed on the second reflection surface 470a and servo control for tracking and focusing is performed using the second reflection 470a. As the holographic data is recorded in a multilayer structure in the depth direction of the data storage medium 400, a high density recording is possible.

The reproduction of the recorded holographic data means that the photodetection unit 550 detects an optical signal from the data storage medium 400. When a reference beam having the same wavelength as that during recording is emitted from the light source 400 to the data storage medium 400, the reference beam is diffracted and transmitted by the recorded hologram. Also, as the reference beam is diffracted by the recorded hologram, a signal beam is generated. The photodetection unit 550 selects one of the diffracted reference beam and the restored signal beam as the reproduction signal to reproduce the recorded data. The drawings illustrate a case in which the reference beam is selected as the reproduction signal. In this case, the signal beam corresponding to noise is blocked by the second beam block unit 450 and is not incident on the photodetection unit 550. During reproduction, the servo control of the second lens 230 is performed using the second reflection surface 470a and the servo control for tracking and focusing of the focusing lens 500 is performed using the first reflection surface 430a. The focusing lens 500 focuses such that the beam corresponding to the reproduction signal proceeds toward the photodetection unit 550. The photodetection unit 550 detects the beam selected as the reproduction signal and reproduces data.

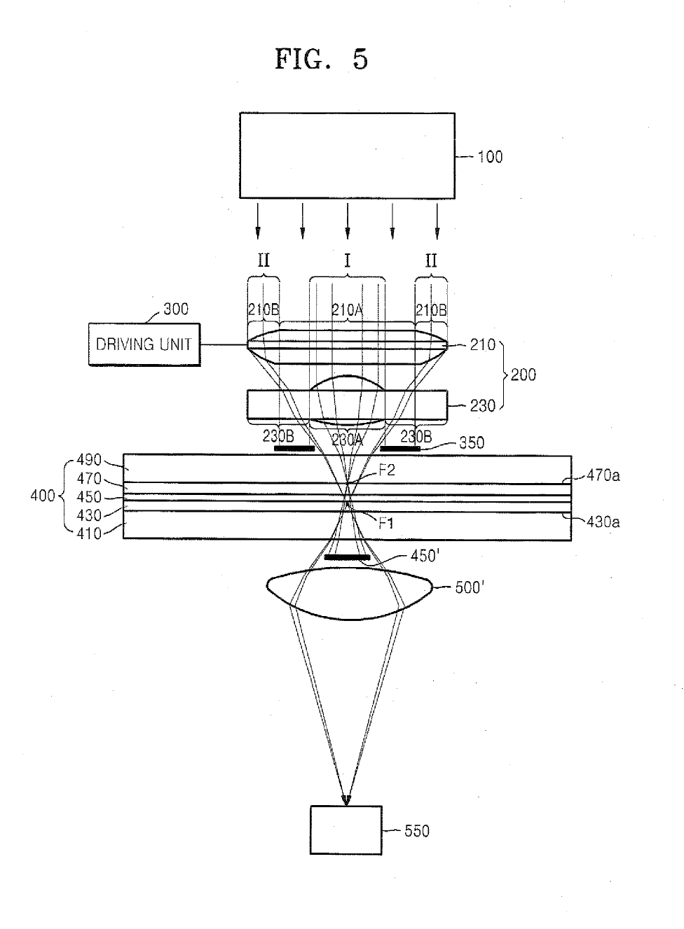

FIG. 5 illustrates the structure of a holographic data recording/reproducing apparatus according to another exemplary embodiment of the present invention. The apparatus for recording/reproducing holographic data includes a light source 100 emitting a laser beam toward a data storage medium 400, a lens unit 200 focusing the laser beam emitted from the light source 100 by classifying the laser beam into a reference beam passing through a first area I and a signal beam passing through a second area II, and a driving unit 300. The above apparatus includes the photodetection unit 550 arranged on the side of the data storage medium 400 opposite to the side of the lens unit 200 to reproduce data by detecting an optical signal from the data storage medium 400. The recording of the holographic data in the data storage medium 400 in a multilayer structure by moving the focus F₁ of the first lens 210 using the driving unit 300 in the holographic data recording/reproducing apparatus according to the present embodiment is the same as that described with reference to FIGS. 3 and 4. However, the reproduction of the recorded data by selecting the signal beam restored by the reference beam as the reproduction signal during reproduction, is the only difference from the embodiment of FIG. 3. Thus, the difference will be described herein.

A second beam block unit 450′ blocks the diffracted reference beam from being incident on the photodetection unit 550. A focusing lens 500′ focuses the restored signal beam on the photodetection unit 550, which is a lens capable of focusing light. Although in the drawing the second beam block unit 450′ is illustrated to be located in front of the focusing lens 500′, it can be located at the rear of the focusing lens 500′. Also, not only the illustrated shape, but also the first lens 210 of FIG. 3 can be used as the focusing lens 500′. That is, the area corresponding to the reference beam is flat without a refractive power and the area corresponding to the signal beam only has a refractive power. Furthermore, the area corresponding to the reference beam can alternatively be an aperture as a lens for focusing light.

In the above description, the photodetection unit for reproducing the data stored in the holographic data storage medium is described as being arranged on the side of the data storage medium opposite to the side of the lens unit. However, this is merely exemplary and the photodetection unit can be arranged on the same side as the lens unit. In this case, a beam splitter can be further provided to allow the light emitted from the light source to proceed toward the data storage medium and the light from the data storage medium to proceed to the photodetection unit.

As described above, the apparatus for recording/reproducing holographic data according to the exemplary embodiments of the present invention characteristically has the driving unit for driving the lens unit to allow the focus to vary in the depth direction of the data storage medium during data recording. Accordingly, the holographic data can be stored in the data storage medium in a multilayer structure.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. An apparatus for recording and reproducing holographic data, which records holographic data in a data storage medium and reproduces the recorded data, the apparatus comprising:
a light source that emits a laser beam;
a lens unit that focuses the laser beam emitted from the light source by classifying the laser beam into a reference beam passing through a first area, and a signal beam passing through a second area and having a first lens focusing the signal beam to a first focus and a second lens focusing the reference beam to a second focus; and
a driving unit that drives the first lens to vary the first focus in a depth direction of the data storage medium.

2. The apparatus of claim 1, wherein in the first lens, an area corresponding to the signal beam only has a refractive power to focus light.

3. The apparatus of claim 2, wherein in the first lens the area corresponding to the signal beam is a first lens area having the refractive power to focus light, and an area corresponding to the reference beam is a first flat area not having the refractive power.

4. The apparatus of claim 2, wherein in the first lens, an area corresponding to the reference beam is an aperture.

5. The apparatus of claim 1, wherein the in the second lens, an area corresponding to the reference beam only has a refractive power to focus light.

6. The apparatus of claim 5, wherein in the second lens, the area corresponding to the reference beam is a second lens area having the refractive power to focus light, and an area corresponding to the signal beam is a second flat area not having the refractive power.

7. The apparatus of claim 5, wherein the second lens is an objective lens having a diameter corresponding to the reference beam.

8. The apparatus of claim 1, further comprising a first beam block unit that blocks a beam of the laser beam passing through the first flat area and the second flat area from being incident on the data storage medium.

9. The apparatus of claim 1, wherein the driving unit is one of a voice coil motor and a piezoelectric ultrasonic motor.

10. The apparatus of claim 1, further comprising a photodetection unit that detects an optical signal from the data storage medium.

11. The apparatus of claim 10, wherein the photodetection unit is arranged on a side of the data storage medium opposite to the side of the lens unit.

12. The apparatus of claim 11, further comprising a focusing lens arranged on an optical path between the data storage medium and the photodetection unit.

13. The apparatus of claim 11, further comprising a second beam block unit arranged on the optical path between the data storage medium and the photodetection unit, wherein the second beam block unit allows only a light beam corresponding to a reproduction signal of the optical signal from the data storage medium to proceed to the photodetection unit.

14. The apparatus of claim 10, wherein the photodetection unit is arranged on a same side of the data storage medium as the light source.

15. The apparatus of claim 14, further comprising a beam splitter that allows light emitted from the light source to proceed to the lens unit, and allows light from the data storage medium to proceed to the photodetection unit.

16. A holographic data storage medium that records holographic data, the holographic data storage medium comprising:
a substrate;
a first buffer layer formed on the substrate;
a first reflection surface having a partially reflecting characteristic formed as a first boundary surface, between the substrate and the first buffer layer;
a recording layer formed on the first buffer layer;
a second buffer layer formed on the recording layer;
a cover layer formed on the second buffer layer; and
a second reflection surface having a partially reflecting characteristic formed as a second boundary surface, between the substrate and the first buffer layer,
wherein the second reflection surface provides servo control during recording, and the second reflection surface and the first reflection surface provides the servo control during reproduction.

17. The holographic data storage medium of claim 16, wherein the recording layer comprises a photosensitive material.

18. A method for recording and reproducing holographic data by classifying a laser beam into a reference beam and a signal beam, and projecting the classified laser beam onto a data storage medium to record data using an interference pattern of the reference beam and the signal beam, and reproducing the recorded data, the method comprising:
forming a focus of the reference beam at a position having a depth in the data storage medium, and allowing a focus of the signal beam to vary in a depth direction of the data storage medium,
wherein the data is recorded in a multilayer structure in the depth direction.

19. The method of claim 18, wherein the data storage medium further comprises a first buffer layer, a recording layer, a second buffer layer, and a cover layer formed by sequentially deposited on a substrate, and a boundary surface between the substrate and the first buffer layer which is a first reflection surface having a partially reflecting characteristic and a boundary surface between the cover layer and the second buffer layer which is a second reflection surface having a partially reflecting characteristic.

20. The method of claim 19, wherein the second reflection surface provides servo control during recording and the second reflection surface and the first reflection surface provides the servo control during reproduction.
